(19) United States
(12) Patent Application Publication
(10) Pub. No.: US 2017/0187465 A1
(43) Pub. Date: Jun. 29, 2017

(54) OPTICAL TRANSMITTER AND METHOD OF CONTROLLING OPTICAL TRANSMITTER

(71) Applicant: FUJITSU LIMITED, Kawasaki-shi (JP)

(72) Inventors: Tomohiro Kaneoka, Kawasaki (JP); Hiroshi Ogiwara, Kawasaki (JP)

(73) Assignee: FUJITSU LIMITED, Kawasaki-shi (JP)

(21) Appl. No.: 15/383,504

(22) Filed: Dec. 19, 2016

(30) Foreign Application Priority Data
Dec. 24, 2015 (JP) 2015-252433

(51) Int. Cl. H04B 10/556; H04B 1/04

(52) U.S. Cl. CPC H04B 10/5561; H04B 1/04

(57) ABSTRACT

An optical transmitter includes: a modulator; and a controller configured to control an extinction state, brought about by the modulator, through I control and Q control in which an offset is added to φ bias and φ control which is performed in a state in which the offset is added to I bias and Q bias.

### CROSS-REFERENCE TO RELATED APPLICATION

This application is based upon and claims the benefit of priority of the prior Japanese Patent Application No. 2015-252433, filed on Dec. 24, 2015, the entire contents of which are incorporated herein by reference.

### FIELD

The embodiment discussed herein is related to an optical communication technique.

### BACKGROUND

In an optical transmitter in a 100 Gbps coherent optical communication system, modulation signals based on a dual polarization quadrature phase shift keying (DP-QPSK) modulation method are generated. A Mach-Zehnder (MZ) modulator is used to generate the modulation signals based on the DP-QPSK modulation method.

Related art is disclosed in Japanese Laid-open Patent Publication No. 2012-217127.

### SUMMARY

According to an aspect of the embodiments, an optical transmitter includes: a modulator; and a controller configured to control an extinction state, brought about by the modulator, through I control and Q control in which an offset is added to φ bias and φ control which is performed in a state in which the offset is added to I bias and Q bias.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a unit configuration of an optical transmitter;

FIG. 2 illustrates an example of a modulator;

FIG. 3 illustrates an example of an extinction state of an optical transmitter;

FIG. 4 illustrates an example of extinction ratios in I/Q control;

FIG. 5 illustrates an example of offsets for I, Q, φ bias components in the extinction state brought about in the modulator;

FIG. 6 illustrates an example of units of an optical transmitter;

FIG. 7 illustrates an example of processing in a controller in the extinction state; and

FIG. 8 illustrates an example of processing in the controller in an emission state.

### DESCRIPTION OF EMBODIMENT

Optimum bias voltages in an MZ modulator drift in accordance with a temperature, interannual variation, and the like, for instance. Auto bias control (ABC) with follow-up to the optimum bias values may be exerted in order to maintain quality of transmission optical signals.

In an optical transmitter that carries out the auto bias control, for instance, a controller exerts control over bias voltages under an initial state in which modulation signals are not input from a modulation signal drive unit into an optical modulation unit. Based on results of the control under the initial state, subsequently, the controller exerts control over the bias voltages under a normal state in which the modulation signals are input from the modulation signal drive unit into the optical modulation unit.

When a modulator is controlled, control over φ (phase angle), I (in-phase), and Q (orthogonal) biases is carried out based on monitor information output from photo diodes (PDs) built in the modulator. In relation to arrangement of the PD, an inverting monitor that allows reductions in a size of and loss in the modulator and that is for monitoring of leakage light having interfered in a multiplexer is used.

When output of signal light in the modulator is brought into an extinction state, a controller in the modulator may control all of the φ, I, and Q biases to extinction points. Remaining components not extinguished in the I/Q controller, however, interfere with one another on the inverting monitor and thus the control over the biases may be made instable. The output of the signal light in the extinction state in the modulator with use of the inverting monitor may be stabilized, for instance.

In a state in which each of the IQ biases in the modulator is extinguished, it may be difficult to stably control the φ bias. In order to stably control the φ bias, offsets may be added to IQ components in the control over the φ bias, for instance. For instance, transition from the extinction state to an emission state may be caused by a shift in the φ bias by approximately 90 degrees.

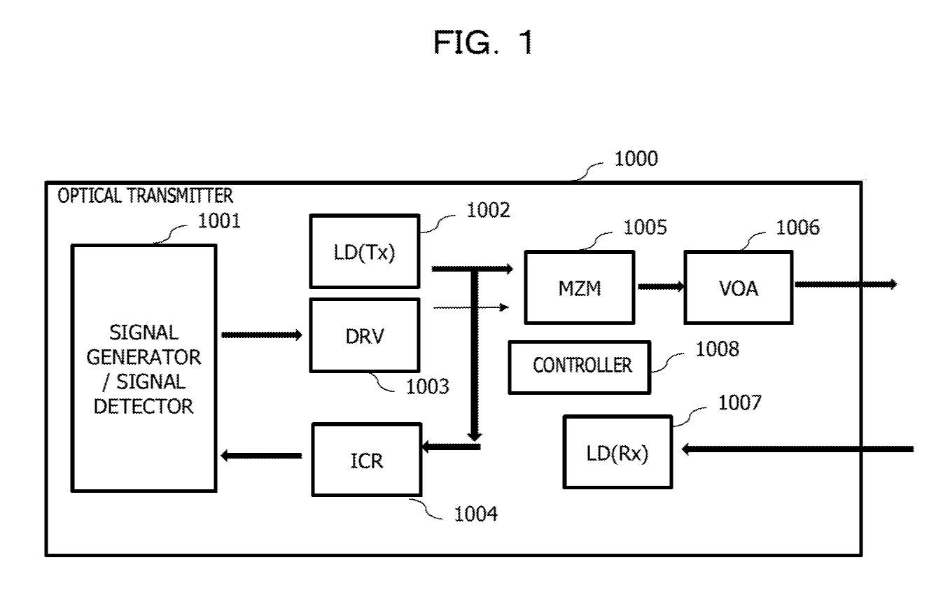

FIG. 1 illustrates an example of a unit configuration of an optical transmitter. The optical transmitter 1000 illustrated in FIG. 1 includes a signal generator/signal detector 1001, a laser diode (LD) (Tx) 1002, a driver (DRV) 1003, an integrated coherent receiver (ICR) 1004, a Mach-Zehnder modulator (MZM) 1005, a variable optical attenuator (VOA) 1006, an LD (Rx) 1007, and a controller 1008.

The signal generator/signal detector 1001 may be an arithmetic processing unit for performing digital signal processing. In a system in which digital coherent technology is used, provision of digital signal processing circuits in transmitter-receiver circuits makes it possible to carry out high-efficient and stable long-distance transmission with use of phase and polarization that are natures of light as waves.

Signals processed by the signal generator/signal detector 1001 are input into the DRV 1003. The DRV 1003, which may be a modulation driver, amplifies the input signals and supplies modulation signals to the MZM 1005.

The LD (Tx) 1002, which may be a laser diode, outputs laser light to the MZM 1005 and the ICR 1004. The MZM 1005 applies voltages to two optical paths of an MZ interferometer and thereby changes phases of light beams in the optical paths so as to control an interference condition. The light beams having passed through the two optical paths are multiplexed again and output. The MZM 1005 controls intensity and phase of the multiplexed light beam in accordance with difference between quantities of phase change that the two light beams undergo in the optical paths. The light beams multiplexed in the MZM 1005 are guided to the VOA 1006.

The VOA 1006 may be a variable optical attenuator. The VOA 1006 regulates intensity of optical signals guided from the MZM 1005. Output from the VOA 1006 is coupled to a transmission path. The LD (Rx) 1007 outputs laser light to the ICR 1004. The ICR 1004 may be an integrated optical receiver module. The controller 1008 may be a control module that controls each of the LD (Tx) 1002, the DRV 1003, the ICR 1004, the MZM 1005, the VOA 1006, and the LD (Rx) 1007.

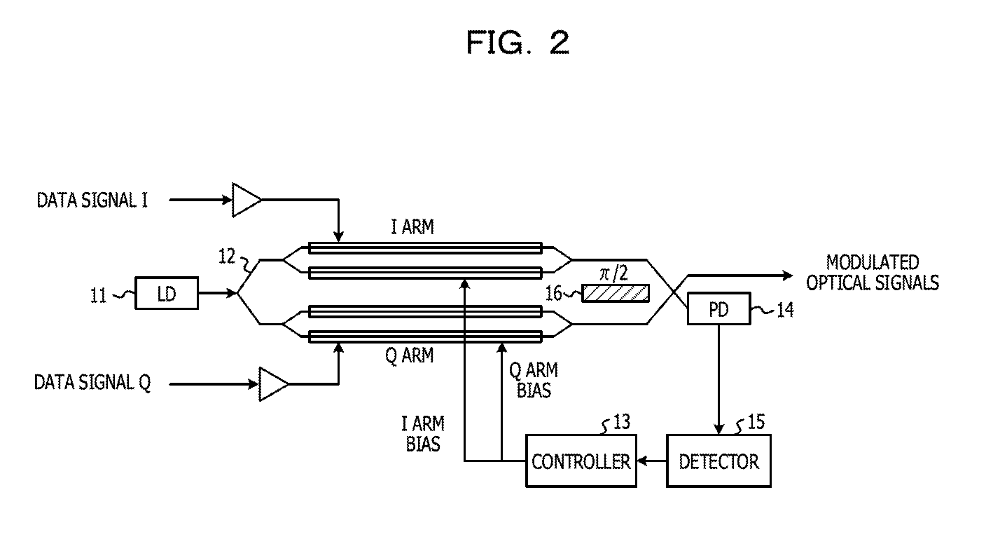

FIG. 2 illustrates an example of a modulator. The optical transmitter includes a light source (LD) 11 and an optical modulator 12. The optical modulator 12, which may be an MZ modulator, includes an I-arm and a Q-arm. The optical modulator 12 includes a phase shifter 16 for providing a phase difference of π/2 between the I-arm and the Q-arm.

The LD 11 generates continuous wave (CW) light. The CW light is bifurcated by an optical splitter and guided to the I-arm and the Q-arm of the optical modulator 12. Data signals I and data signals Q are respectively provided into the I-arm and the Q-arm of the optical modulator 12. The data signals I and the data signals Q have an amplitude of 2 Vπ, for instance. Vπ may be a voltage corresponding to a half cycle of characteristics of drive voltage to light intensity in the modulator. In the I-arm, the continuous wave light is modulated with use of the data signals I so that I-arm modulated optical signals are generated. In the Q-arm, similarly, the continuous wave light is modulated with use of the data signals Q so that Q-arm modulated optical signals are generated. QPSK modulated optical signals are generated by multiplexing of the I-arm modulated optical signals and the Q-arm modulated optical signals.

In the above-described optical transmitter, bias voltages for the I-arm and the Q-arm may appropriately be controlled respectively in order that high quality optical signals may be generated. For instance, the optical transmitter may include a controller 13, a photodiode (PD) 14, and a detector 15 in order to control the bias voltages for the optical modulator 12.

The controller 13 superimposes low-frequency signals (pilot tone) on the bias voltages for the optical modulator when controlling I, Q, and φ during the emission or controlling I and Q during the extinction. The modulated optical signals output from the optical modulator 12 include frequency components of the low-frequency signals. The PD 14 converts the modulated optical signals, output from the optical modulator 12, into electric signals. Based on the electric signals generated by the PD 14, the detector 15 detects intensities and phases of the frequency components included in the modulated optical signals. The controller 13 carries out feedback control over the bias voltages for the I-arm and the Q-arm so that the frequency components included in the modulated optical signals approach zero (this may be referred to as low-frequency signal superposition method, hereinbelow). Thus the bias voltages for the I-arm and the Q-arm may be optimized so that high-quality optical signals may be generated. The feedback control described above may be referred to as the auto bias control. The controller 13 may perform the above-mentioned function by use of software, for instance. The controller 13 may perform the above-mentioned function by use of software and hardware circuits, for instance. Operation of the software may be carried out with use of processors and memories.

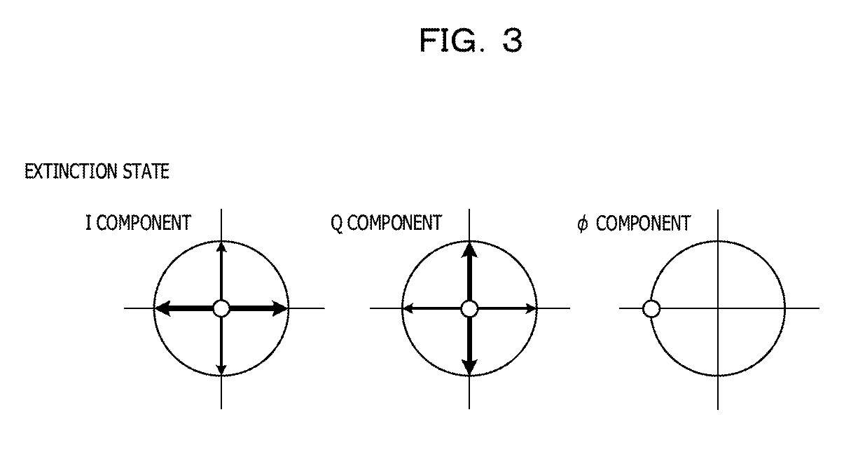

FIG. 3 illustrates an example of the extinction state of an optical transmitter. In the extinction state of the optical transmitter 1000, φ is set at approximately 180 degrees. Setting φ with an offset of approximately 180 degrees causes I and Q of the IQ components in the optical transmitter 1000 to cancel each other. As illustrated in FIG. 3, therefore, the extinction state may be brought about by such setting of the I component and the Q component as causes the I component and the Q component to approach zero.

Causing the IQ components to approach zero point may result in interference of leakage light not extinguished by I and Q, consequent inverting operation on the monitor, and instability in the control over the φ bias. The instability in the φ bias may interrupt maintenance of the extinction state of the optical transmitter.

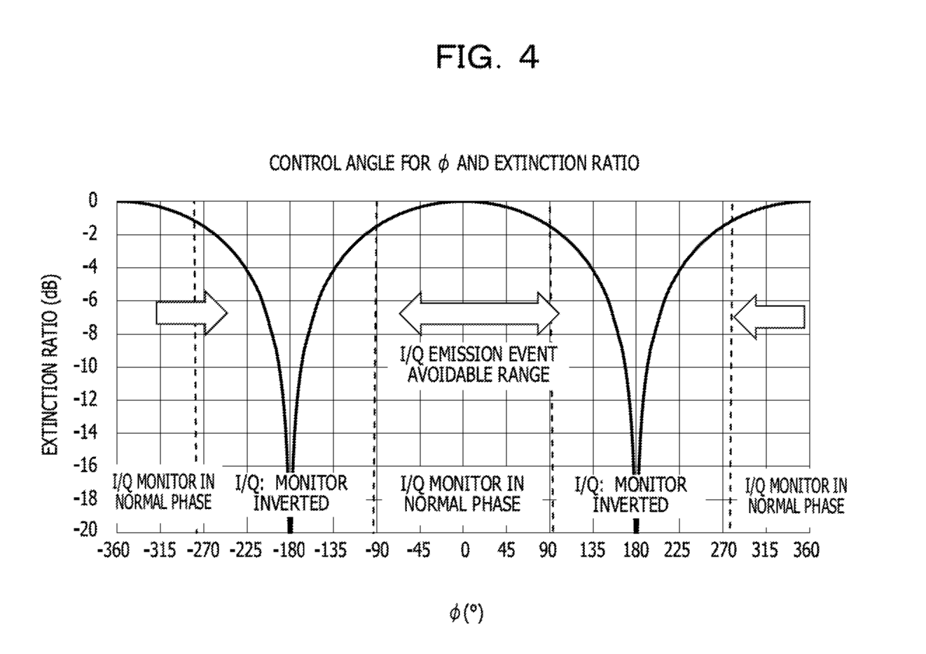

FIG. 4 illustrates an example of extinction ratios in the I/Q control. FIG. 4 illustrates a correspondence relation between φ (horizontal axis: phase angle) and the extinction ratio (vertical axis: dB) in the optical transmitter 1000 during the I/Q control. The extinction ratio is a ratio to a maximum light output that is obtained when the phase angle is changed by addition of the bias voltage to φ.

In FIG. 4, the interference between I and Q on the monitor may be treated as normal phase, on condition that φ is between −360 degrees and −270 degrees, between −90 degrees and 90 degrees, and between 270 degrees and 360 degrees. On condition that φ is between −270 degrees and −90 degrees and between 90 degrees and 270 degrees, the interference between I and Q on the monitor is inverted.

When φ is controlled so as to be at approximately 180° in the control over the I bias or the Q bias, the extinction state is made instable due to the inverting monitor. Therefore, an offset of approximately 180° is given to φ in order that the remaining components of I and Q may appear in the normal phase on the monitor. Thus stable extinction state may be obtained.

On condition that a high extinction ratio is obtained for I and Q, light input into the PD is made minute and the φ bias is thus made more prone to be swung in response to slight change in the IQ biases. Therefore, for stable control over the φ bias, monitor signals may be left by addition of given offsets to the IQ components in the control over the φ bias, so that φ may stably be controlled so as to be at approximately 180°. Thus the φ bias in the extinction state may be stabilized.

The light output in the extinction state may be stabilized by above-mentioned two offset processes.

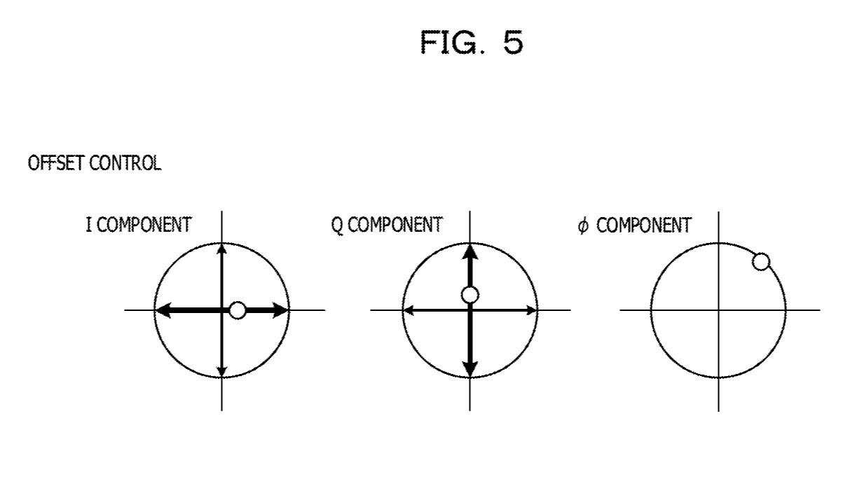

FIG. 5 illustrates an example of the offsets for the I, Q, φ bias components in the extinction state brought about in the modulator. The controller 13 sets 45 degrees, for instance, for φ. Thus instability in the extinction state that might be caused by influence of the inverting monitor may be avoided. The controller 13 adds the offsets to the IQ biases in the control over φ and carries out the control so as to leave a given emission state. Thus the φ bias may be stabilized.

In the extinction state, the controller 13 may make the modulator perform processing in a sequence as follows, for instance.

The controller 13 may perform the following control, for instance.

(A1) The controller 13 adds the offsets to the IQ biases and carries out the φ bias control. The controller 13 performs subtraction of the offsets after the processing (A1).

(A2) The controller 13 adds the offset to the φ bias and carries out the I bias control. The controller 13 performs subtraction of the offset after the processing (A2).

(A3) The controller 13 adds the offset to the φ bias and carries out the Q bias control. The controller 13 performs subtraction of the offset after the processing (A3).

The controller 13 iterates the processing (A1) through (A3) and identifies the biases that minimize power. The addition of the offsets to the IQ components in the control over the φ bias in the extinction state may enable the stable control over the φ bias, for instance. The stable extinction state may be obtained by the addition of the offset to the φ component in the control over the I bias and the Q bias. Thus the above-described modulator may provide the stable extinction state.

The controller 13 may perform the following control, for instance.

(B1) The controller 13 adds the offsets to the IQ biases and carries out the φ bias control. The controller 13 performs subtraction of the offsets after the processing (B1).

(B2) The controller 13 adds the offset to the φ bias and carries out the I bias control. The controller 13 performs subtraction of the offset after the processing (B2).

(B3) The controller 13 adds the offsets to the IQ biases and carries out the φ bias control. The controller 13 performs subtraction of the offsets after the processing (B3).

(B4) The controller 13 adds the offset to the φ bias and carries out the I bias control. The controller 13 performs subtraction of the offset after the processing (B4).

The controller 13 iterates the processing (A1) through (A4) or (B1) through (B4) and identifies the biases that minimize the power. The addition of the offsets to the IQ components in the control over the φ bias in the extinction state may enable the stable control over the φ bias, for instance. The stable extinction state may be obtained by the addition of the offset to the φ component in the control over the I bias and the Q bias. Thus the modulator may provide the stable extinction state.

On occasion of start-up of the optical transmitter when the extinction state is turned into the emission state, as illustrated in FIG. 3, the optical transmitter may narrow a signal spectrum so as to increase a wavelength that may be transmitted at a time, for instance. In cases where the optical transmitter is started up with use of Nyquist signals while radio frequency (RF) signals are in ON state, a driving amplitude may be decreased and the auto bias control may be made unstable. Such an event may be referred to as “wrong convergence”. The wrong convergence may cause output of unwanted signals toward network side, crosstalk to adjacent signals, and deterioration in signal quality.

In the above-described optical transmitter, such wrong convergence may be avoided by the transition from the extinction state to the emission state as illustrated in FIG. 5. The controller 13 stops the ABC in the extinction state of FIG. 5 and causes a shift (addition) by approximately −90 degrees in the φ bias, for instance. After that, the controller 13 turns on RF signals so as to resume the ABC and may thus start up the Nyquist signals without causing influence on the adjacent signals and the wrong convergence. The controller 13 superimposes the pilot tone and carries out the control so that an amplitude of the pilot tone becomes zero.

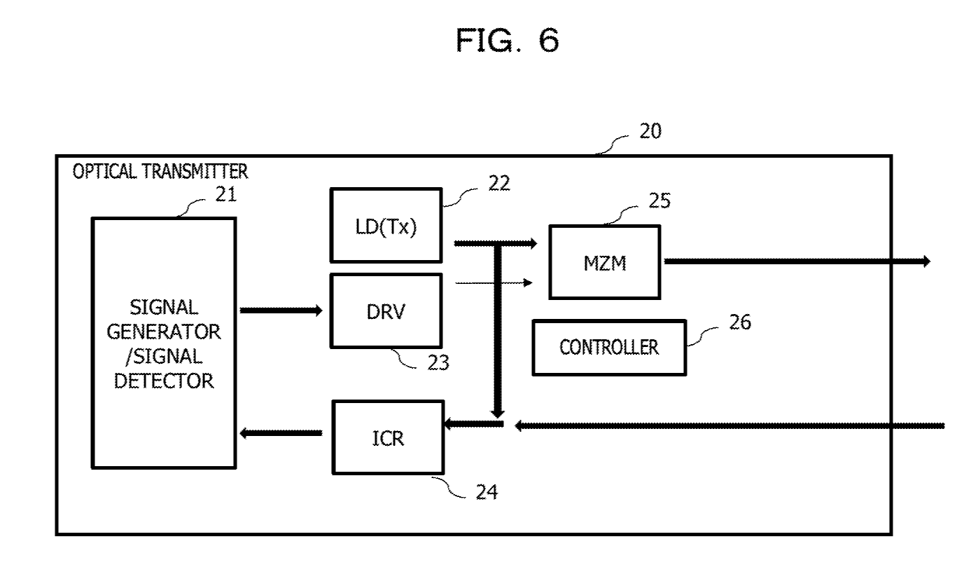

FIG. 6 illustrates an example of units of an optical transmitter. The optical transmitter 20 illustrated in FIG. 6 includes a signal generator/signal detector 21, an LD (Tx) 22, a DRV 23, an ICR 24, an MZM 25, and a controller 26. Each processing of the signal generator/signal detector 21, the LD (Tx) 22, the DRV 23, the ICR 24, the MZM 25, and the controller 26 is substantially the same as or similar to that in respective units of the optical transmitter 1000 of FIG. 1 may be performed. The controller 26 illustrated in FIG. 6 may be substantially the same as or similar to the controller 13 illustrated in FIG. 2.

The optical transmitter 20 illustrated in FIG. 6 has the unit configuration in which the VOA 1006 and the LD (Rx) 1007 have been removed from the optical transmitter 1000 of FIG. 1. The controller 1008 of the optical transmitter 1000 may finally perform control over light of the LD (Tx) 1002 by controlling opening and closing of the VOA 1006.

The controller 26 may bring about the extinction state by controlling the MZM 25. Therefore, the optical transmitter 20 may lack the VOA 1006. The LD (Rx) 1007 may be omitted with use of a laser for both transmission and reception as the LD (Tx) 22. In this configuration, output of the LD (Tx) 22 may be bifurcated and then used as local light for the ICR 24.

In control over the MZM 25, the stable control over the φ bias may be enabled by the addition of the offsets to the IQ components in the control over the φ bias in the extinction state. The stable extinction state may be obtained by the addition of the offset to the φ component in the control over the IQ biases. Thus the above-mentioned LN modulator may provide the stable extinction state. The above-mentioned functions may be attained by the unit configuration of the optical transmitter 1000 of FIG. 1 and the unit configuration of the optical transmitter 20 of FIG. 6.

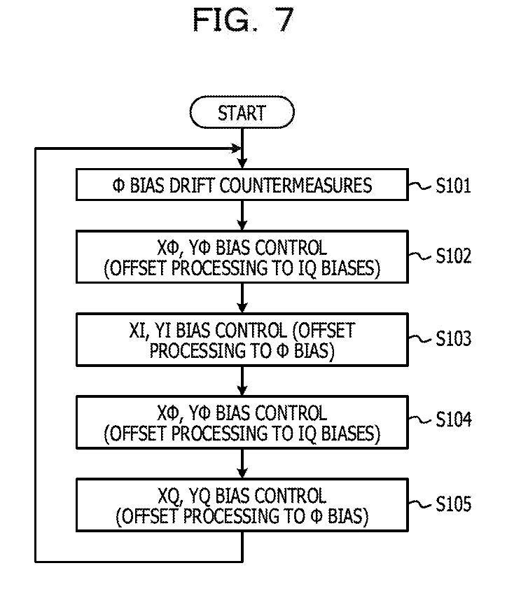

FIG. 7 illustrates an example of the processing of the controller for transition from the emission state to the extinction state. The controller 26 carries out countermeasures against the drifts in the φ bias as the ABC control in the MZM 25 (operation S101). The controller 26 adds the offsets to the IQ biases and carries out the φ bias control (operation S102). The controller 26 adds the offset to the φ bias and carries out the I bias control (operation S103). The controller 26 adds the offsets to the IQ biases and carries out the φ bias control (operation S104). The controller 26 adds the offset to the φ bias and carries out the I bias control (operation S105). Once the operation S105 is ended, the controller 26 iterates processing starting from the operation S101 and identifies the biases that minimize the power. The offsets added in the operations S102 through S105 are reset in every operation and are not continued to subsequent processing. The stable extinction state may be obtained by the addition of the offset to the φ component in the control over the IQ biases in the extinction state, for instance. The addition of the offsets to the IQ components in the control over the φ bias may enable the stable control over the φ bias. The modulator may provide the stable extinction state.

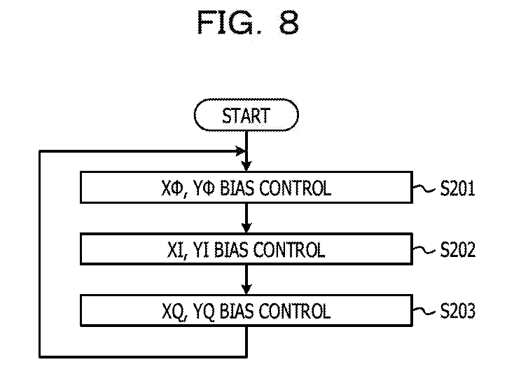

FIG. 8 illustrates an example of the processing of the controller for the transition from the extinction state to the emission state. The controller 26 may perform following processing in order to make the transition from the extinction state to the emission state as illustrated in FIG. 5. The controller 26 causes the shift by approximately −90 degrees in the φ bias in the MZM 25 and thereafter carries out the control over the φ bias (operation S201). The controller 26 carries out the control over the φ bias (operation S202). The controller 26 carries out the control over the Q bias (operation S203). The pilot tone is superimposed in each operation and the operations S201 through S203 are iterated so that the amplitude of the pilot tone becomes zero.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmitter comprising:
a modulator; and
a controller configured to control an extinction state, brought about by the modulator, through I control and Q control in which an offset is added to φ bias and φ control which is performed in a state in which the offset is added to I bias and Q bias.

2. The optical transmitter according to claim 1,
wherein the controller brings about the extinction state through control in order of the φ control, the I control, the φ control, and the Q control.

3. The optical transmitter according to claim 1,
wherein the controller brings about the extinction state through a shift by approximately +90 degrees from an emission state, subsequent turn-off of an radio frequency (RF) signal, and the control in order of the φ control, the I control, the φ control, and the Q control.

4. The optical transmitter according to claim 2,
wherein the controller brings about an emission state through a shift in the φ bias by approximately −90 degrees from the extinction state, subsequent turn-on of a radio frequency (RF) signal, control over the φ bias, control over the I bias, and control over the Q bias.

5. The optical transmitter according to claim 1,
wherein the controller brings about the extinction state through control in order of the φ control, the I control, and the Q control.

6. The optical transmitter according to claim 1,
wherein the controller brings about the extinction state through a shift by approximately +90 degrees from an emission state, subsequent turn-off of a radio frequency (RF) signal, and control in order of the φ control, the I control, and the Q control.

7. A method of controlling an optical transmitter, the method comprising:
performing I control and Q control in which an offset is added to φ bias in a modulator;
performing φ control in a state in which the offset is added to I bias and Q bias; and
controlling an extinction state brought about by the modulator.

8. The method according to claim 7, further comprising:
generating the extinction state through control in order of the φ control, the I control, the φ control, and the Q control.

9. The method according to claim 7, further comprising:
generating the extinction state through a shift by approximately +90 degrees from an emission state, subsequent turn-off of an radio frequency (RF) signal, and the control in order of the φ control, the I control, the φ control, and the Q control.

10. The method according to claim 8, further comprising:
generating an emission state through a shift in the φ bias by approximately −90 degrees from the extinction state, subsequent turn-on of a radio frequency (RF) signal, control over the φ bias, control over the I bias, and control over the Q bias.

11. The method according to claim 7, further comprising:
generating the extinction state through control in order of the φ control, the I control, and the Q control.

12. The method according to claim 7, further comprising:
generating the extinction state through a shift by approximately +90 degrees from an emission state, subsequent turn-off of a radio frequency (RF) signal, and control in order of the φ control, the I control, and the Q control.
